(19) United States
(12) Patent Application Publication
(10) Pub. No.: US 2007/0027806 A1
(43) Pub. Date: Feb. 1, 2007

(54) ENVIRONMENT-DRIVEN APPLICATIONS IN A CUSTOMER SERVICE ENVIRONMENT, SUCH AS A RETAIL BANKING ENVIRONMENT

(75) Inventors: Ian Michael Sands, Seattle, WA (US); Victor Kevin Russ, Seattle, WA (US)

Correspondence Address: PERKINS COIE LLP/MSFT, P. O. BOX 1247, SEATTLE, WA, 98111-1247, US

(73) Assignee: Microsoft Corporation, Redmond, WA (US)

(21) Appl. No.: 11/456,042

(22) Filed: Jul. 6, 2006

Related U.S. Application Data
(60) Provisional application No. 60/703,548, filed on Jul. 29, 2005.

(51) Int. Cl. G06Q 40/00

(52) U.S. Cl. 705/42

(57) ABSTRACT

Providing enhanced customer service within an environment. A customer identification subsystem configured to automatically identify a customer that has entered the environment and a customer tracking subsystem configured to automatically track activities, current locations, or both activities and current locations of the identified customer within the environment may provide input to a context processing component and/or at least one environment-driven application. The context processing component, if provided, may be configured to determine a current or near current context for the identified customer based on information provided by the customer identification subsystem and the customer tracking subsystem. The at least one environment-driven application may be configured to use customer context information provided by the context processing component (or derived independently) to facilitate providing customized customer service to the customer.

### CROSS-REFERENCE TO RELATED APPLICATION

This application claims priority to U.S. Application No. 60/703,548, filed Jul. 29, 2005, entitled “Device/Human Interactions, such as in Context-Aware Environments,” which is herein incorporated by reference.

### BACKGROUND

Computers and computing devices are finding their way into more and more aspects of daily life. For example, computing devices are found both inside the home (e.g., personal computers, media devices, communication devices, etc.) and outside the home (e.g., bank computers, supermarket checkout computers, computers in retail stores, computer billboards, computing devices relating to providing commercial services, computing devices in cars, etc.). Most of these computing devices have mechanisms that allow them to interact with humans and/or the environment at some level. Aspects of the way that computing devices interact with humans are sometimes referred to as a “user experience.” For example, a human's satisfaction with a computing device interaction (or sequence of computing device interactions) may be based, at least in part, on the richness and/or productivity of the user experience. In addition, various aspects of the environment (including the physical environment) in which the computing device operates to interact with humans may play a role in shaping the user experience.

Computers are also used in providing customer/user service and assistance in a number of environments (e.g., banks, schools, hotels, stores, restaurants, airports, hospitals, libraries, etc.). However, while customer service and assistance are typically facilitated by the use of computers and computer applications, often the computer serves merely as the access point into some sort of database, instead of more fully facilitating customer service.

### SUMMARY

The methods and systems described herein facilitate providing enhanced customer service and/or user assistance within an environment through one or more environment-driven applications that respond to input regarding, for example, a customer's identity and the customer's current or near current location, status, and/or activity within the environment. For example, the methods and systems described herein may allow customers to come into a bank and, without having to explicitly provide indications about their identities, be automatically “known” or identified by the relevant computing devices so that customized customer service can be provided in an efficient and effective way. This enhanced customer service may be provided by human customer service agents (who rely on aspects of the environment-driven applications to provide customer service) and/or by automated assistance processes.

### BRIEF DESCRIPTION OF THE DRAWINGS

FIG. 1 is a block diagram of an environment in which aspects of the environment-driven technology can be implemented.

FIG. 2 is a block diagram showing details of the customer identification component from the environment of FIG. 1.

FIG. 3 is a block diagram showing details of the customer location tracking component from the environment of FIG. 1.

FIG. 4 is a block diagram showing details of the context analysis component from the environment of FIG. 1.

FIG. 5 is a flow diagram showing an example of a high-level routine for driving an environment-driven application in a customer service environment.

FIG. 6 is a flow diagram showing an example of a context analysis routine in one embodiment.

FIG. 7 is a flow diagram showing an example of a routine performed at an environment-driven application in a first embodiment.

FIG. 8 is a flow diagram showing an example of a routine performed at an environment-driven application in a second embodiment.

FIG. 9 is a display diagram showing a screen shot or view from a bank branch computer displaying aspects of a dashboard application user interface.

### DETAILED DESCRIPTION

The following description provides specific examples of techniques that can be used in association with one or more computing devices to increase the richness and productivity of user experiences. While the description provides many examples in the context of a bank branch, the techniques described herein are not limited to banking contexts and, rather, can be applied in any type of environment associated with computing devices, including environments associated with other commercial activities besides banking, home environments, environments at sporting events, retail environments, manufacturing environments, workplace environments, customer service environments, entertainment environments, science or research environments, educational environments, transportation environments, etc. Depending on the environment, increasing the richness and productivity of user experiences in accordance with some embodiments may improve customer retention, increase the value of individual customer relationships, reduce costs, result in higher sales, drive sales to new customers, and provide many other personal and/or commercial benefits.

I. Employing Aspects of Environment-Driven Application Behavior

One way to increase the richness and productivity of user experiences (applied here to the example of the bank branch) is to allow customers to come into a bank and, without having to explicitly provide indications about their identities, be automatically “known” or identified by the relevant computing devices within the environment. There are various ways that this can be implemented, and some examples are described in more detail below. In some embodiments, the customer may retain control over the extent and scope of the customer information that is automatically available to relevant computing devices and their applications, thus easing concerns with respect to customer privacy issues. For example, customers may be given the option to opt-in/opt-out of having their information known, and may be given a range of disclosure levels from which to choose.

One way in which customers can come into the environment (e.g., bank environment) and be automatically known is by allowing information from the surrounding environment (e.g., the current location or activity of the customer in a physical environment) to drive one or more applications at one or more computing devices. In some embodiments, this may be implemented using RF ID enabled ATM cards, biometrics, authentication mechanisms, mobile device location awareness, presence information, etc. By allowing activities in the environment to drive application behavior, in general, customer service representatives (and even the customers themselves) may be empowered with a host of technology tools that allow them to increase productivity, increase the value of each customer relationship, reduce costs, help to drive sales of products and services in a timely meaningful way, etc. For example, by allowing a bank to identify its customers when they walk in the door (e.g., using RF ID enabled ATM cards or mobile device location awareness), customers may realize enhanced service and high-value customers may realize priority service.

II. Sample Environment

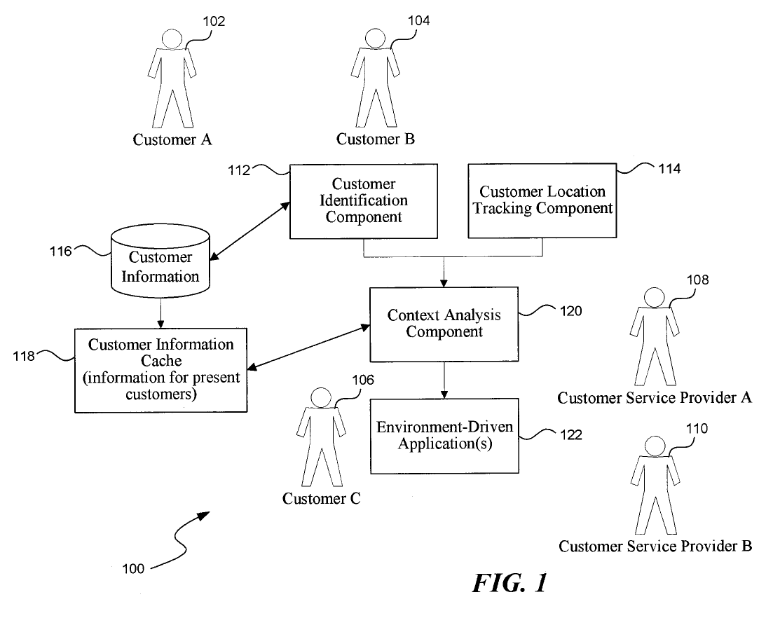

FIG. 1 is a block diagram of a sample environment 100 in which aspects of the environment-driven technologies can be implemented. The sample environment 100 includes at least one customer (customers 102, 104, and 106) and at least one service provider (customer service providers 108 and 110). The at least one service provider (108 and 110) may be a human, or in some embodiments, may be non-human (e.g., an automated kiosk or robot). The function of the at least one service provider (108 and 110) is to provide assistance, guidance, and/or customer service to the at least one customer (customers 102, 104, and 106) in the context of the environment. For example, if the environment is a bank, the at least one service provider (108 and 110) provides assistance to the at least one customer (customers 102, 104, and 106) in opening accounts, making deposits, making withdrawals, etc. If the environment is an airport, the at least one service provider (108 and 110) provides assistance to the at least one customer (customers 102, 104, and 106) in booking flights, checking baggage, locating arrival or departure gates, etc. Banks and airports are but two of many possible environments in which the technology can be implemented.

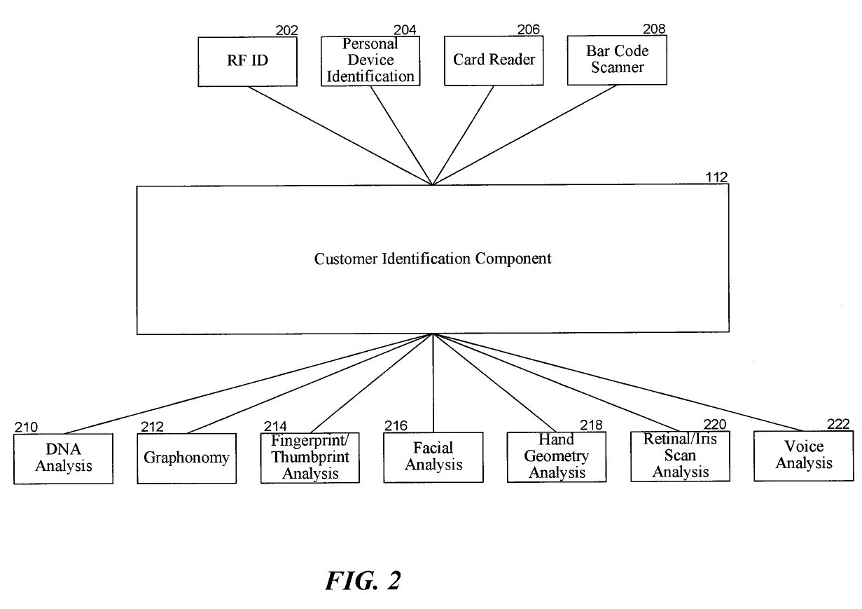

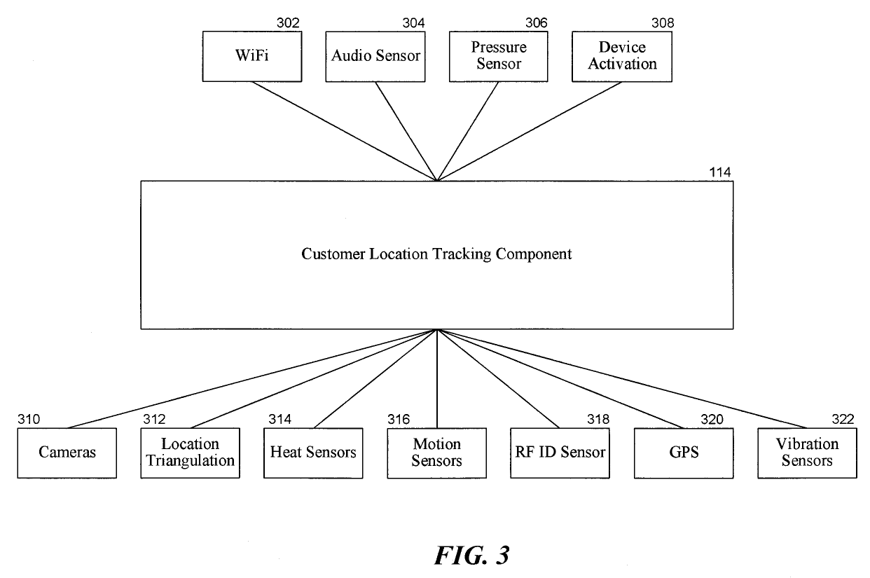

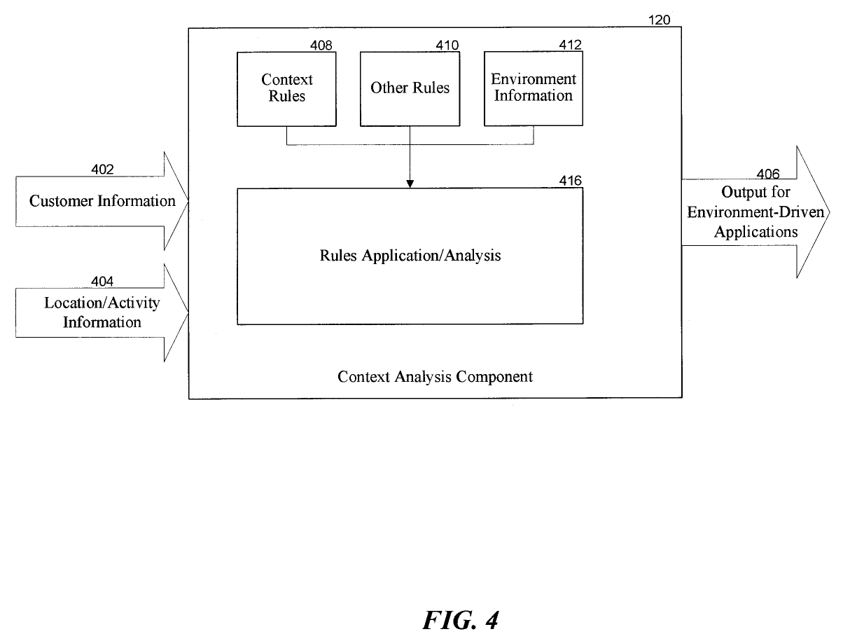

The environment 100 includes and/or communicates with a customer identification component 112, which identifies users (known or unknown) in the environment. Various technologies may be used to implement aspects of the customer identification component 112, some of which are described with respect to FIG. 2. A customer location tracking component 114 tracks the location and/or activities performed by the customer within the environment during each session (e.g., the time period from when the customer is first detected in the environment via the customer identification component 112, until the customer leaves the environment). An example implementation of the customer location tracking component 114 is described with respect to FIG. 3. The customer identification component 112 and/or customer location tracking component 114 may operate based on information from a customer information database 116 and may, likewise, provide updated information for storage within this database 116. Information for customers that are currently in the environment (e.g., those that are in an active session state) may be stored temporarily in a customer information cache 118, so that such information can be quickly accessed (e.g., by a context analysis component 120 and/or environment-driven application(s) 122). Output from the customer identification component 112 and/or the customer location tracking component 114 may be supplied as input to a context analysis component 120, which applies rules and/or algorithms to determine a current or near current context of specified customers during a session within the environment. Additional details about the operation and functionality of the context analysis component 120 are described with respect to FIG. 4.

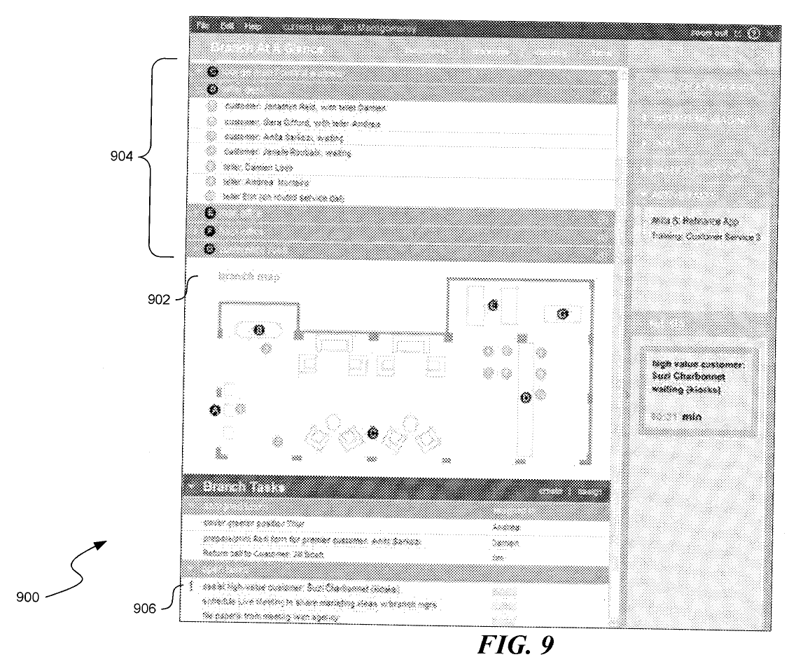

In general, the customer identification component 112, customer location tracking component 114, customer information database 116, customer information cache 118, and context analysis component 120 may alone, or in some combination, provide information that allows the environment-driven application(s) 122 to behave in response to the presence and/or actions of users within the environment and facilitate providing customized assistance to customers within the environment. Some examples of how the environment-driven application(s) 122 may use this information are listed below:
The provided information may facilitate customer service prioritization based on customer awareness, location, and identification.
The provided information may facilitate providing a map and corresponding listing of the location of each customer in the environment (shown in more detail in FIG. 9).
The provided information may facilitate providing alerts to the at least one customer service provider.
The provided information may facilitate having the at least one customer service provider (108 and 110) approach the customer and offer assistance when it is determined that the detected action and/or location of the customer may require such assistance.
The provided information may facilitate matching customers to the appropriate customer service provider (and/or distributing other customer service tasks) so that customers in the environment can each be served efficiently and effectively.
As a customer approaches a kiosk or customer service provider station, the provided information may facilitate having the customer's information appear on a customer service kiosk or customer service provider's computer screen without the customer having to provide such information, therefore saving time and effort.
The provided information may facilitate the generation/management of tasks and customer service workflows.
The provided information may facilitate modifying the state of an environment-driven application on which the teller is working.
The provided information may facilitate other functionality.

FIG. 2 is a block diagram showing details of the customer identification component 112 of FIG. 1, which allows customers to be identified, for example, in a retail setting (e.g., store or bank) and FIG. 3 is a block diagram showing details of the customer location tracking component 114 of FIG. 1, which allows a customer's location and/or activities to be tracked, for example, in a retail setting.

In some embodiments, the customer identification component may interface with one or more devices or technologies to allow the interactive display technologies to determine the identity of users (e.g., customers in a retail setting). Examples of such devices/technologies include RF ID 202; personal device identification technologies 204 (e.g., based on unique signal transmitted by personal device); card readers 206 (e.g., configured to read magnetic strips on personal identification cards); bar code scanners 208 (e.g., configured to read bar codes on card or other item); DNA analysis technologies 210 (e.g., configured to determine identity based on available DNA samples from skin, hair, etc.); graphonomy technology 212 (e.g., configured to determine identity based on handwriting or signatures); fingerprint/thumbprint analysis technology 214; facial analysis technology 216; hand geometry analysis technology 218; retinal/iris scan analysis technology 220; voice analysis technology 222; etc.

Many of these technologies/devices function by having a user register and/or voluntarily provide initial information (e.g., name, biometric information, affiliations, etc.) so that a user profile can be generated. In this way, the user can be identified as soon as the user's presence is subsequently detected within the environment (e.g., by collecting information for each user who enters the environment and then matching this information to find specific user profiles). However, such an initial registration process may not be needed in all cases to generate a user profile. For example, a user profile for an unnamed new user may be initially generated and updated based on collecting available biometric (or other information) for that user, assigning a unique identifier to the user (e.g., an ID number), mapping the unique identifier to the available biometric (or other information), and then subsequently tracking the user's activities within the environment.

Referring to FIG. 3, the customer location tracking component 114 allows a user's location to be tracked as he or she performs activities and/or moves about an environment (e.g., a retail store, bank, library, hospital, airport, etc.). Examples of some of the location tracking devices and/or technology that the customer location tracking component 114 may employ (either alone or in combination) include WiFi technology 302; audio sensors 304; pressure sensors 306 (e.g., to detect contact with a device or area of the environment); device activation technology 308 (e.g., related to other machine or device in environment, such as ATM, work station, computer, check stand, etc.); cameras 310; location triangulation technology 312 (e.g., image based); heat sensors 314; motion sensors 316; RF ID sensors 318; GPS technology 320; vibration sensors 322; etc.

Tracking the user's location and activities within the environment may further control what type of content is to be selected for display to that user, as well as providing more basic information about when a particular user is approaching a display. For example, if a bank customer is approaching a display after having recently made a large deposit into her savings account using an ATM, it may make sense to display content associated with an offer for a new investment opportunity that the customer may potentially be interested in based on the fact that she recently made the deposit.

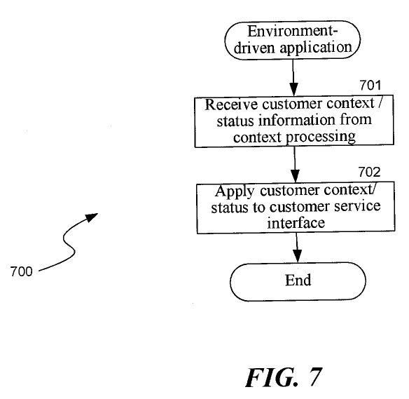

FIG. 4 is a block diagram showing details of the context analysis component 120 from the environment of FIG. 1. Customer information 402 (e.g., obtained from the customer identification component 112, customer information database 116, and/or customer information cache 118) and location/activity information 404 (e.g., obtained from the customer location tracking component 114, customer information database 116, and/or customer information cache 118) function as the input for the context analysis component 120. As the customer's location or activity in the environment changes, additional instances of location/activity information 404 may be provided as input either on an as-needed basis or periodically (e.g., every thirty seconds). A rules application/analysis module 416 of the context analysis component may then apply information such as context rules 408, other rules 410, and environment information 412 to the received input (402 and 404) to produce information about the current or near current context of the customer which can be sent out as output 406 for receipt by environment-driven applications. Alternatively, aspects of the functionality of the context analysis component 120 may be provided by the environment-driven application itself (see, e.g., FIG. 7), allowing the context analysis component 120 to be omitted or simplified in some embodiments.

Components of the system, such as the environment-driven application(s) 122, customer identification component 112, customer location tracking component 114, and context analysis component 120 may operate on one or more computing devices that possibly include a CPU to perform processing, a memory, network modules, and input/output devices. Communication between components of the system may be facilitated by one or more data connections, such as wired and/or wireless data connections (e.g., infrared, Bluetooth, IEEE 802.11, IEEE 802.11a, IEEE 802.11b, IEEE 802.11g, etc.).

In general, any of the computing devices described above may include a central processing unit, memory, input devices (e.g., keyboard and pointing devices), output devices (e.g., display devices), and storage devices (e.g., disk drives). The memory and storage devices are computer-readable media that may contain instructions that implement the system. In addition, the data structures and message structures may be stored or transmitted via a data transmission medium, such as a signal on a communication link. Various communication links may be used, such as the Internet, a local area network, a wide area network, a point-to-point dial-up connection, a cell phone network, and so on.

Embodiments may be implemented in various operating environments that include personal computers, server computers, hand-held or laptop devices, multiprocessor systems, microprocessor-based systems, programmable consumer electronics, digital cameras, network PCs, minicomputers, mainframe computers, distributed computing environments that include any of the above systems or devices, and so on. The computer systems may be cell phones, personal digital assistants, smart phones, personal computers, programmable consumer electronics, digital cameras, and so on.

Embodiments may be described in the general context of computer- executable instructions, such as program modules, executed by one or more computers or other devices. Generally, program modules include routines, programs, objects, components, data structures, and so on that perform particular tasks or implement particular abstract data types. Typically, the functionality of the program modules may be combined or distributed as desired in various embodiments.

II. Sample Flow Diagrams

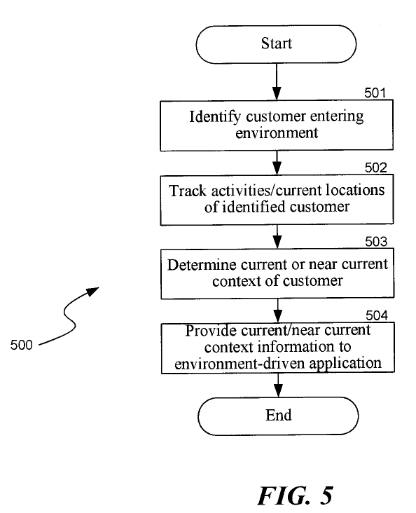

FIG. 5 is a flow diagram showing an example of a high-level routine 500 for driving an environment-driven application in a customer service environment. Aspects of the routine 500 are performed, for example, by various components of the environment of FIG. 1. At block 501, the routine 500 identifies a customer entering the environment. This aspect of the routine 500 may be performed, for example, by the customer identification component 112 of FIG. 1. At block 502, the routine 500 tracks activities and/or the current location(s) of the identified customer. This aspect of the routine 500 may be performed periodically (e.g., every twenty seconds) or as the customer changes location or activity in the environment (e.g., moves from one designated station in the environment to another designated station in the environment). This aspect of the routine 500 may be performed, for example, by the customer location tracking component 114. At block 503, the routine 500 determines a current or near current context of the customer (e.g., customer needs assistance, customer self-sufficient, customer having trouble with electronic transaction, etc.). This determination may be repeated periodically as new information about the activity and/or current location of the customer is received. This determination may be performed, for example, at the context analysis component 120, or at the environment-driven application(s) 122. At block 504, the routine 500 provides current or near current context information to the environment-driven application so that the environment-driven application can facilitate providing customized customer service or assistance to the identified customer. Like the activities of block 502 and 503, in some embodiments, this aspect of the routine 500 may be repeated until the customer session is over (e.g., the customer has left the environment and/or the activity/location tracking has timed out due to lack of new activity). The routine 500 ends after block 504.

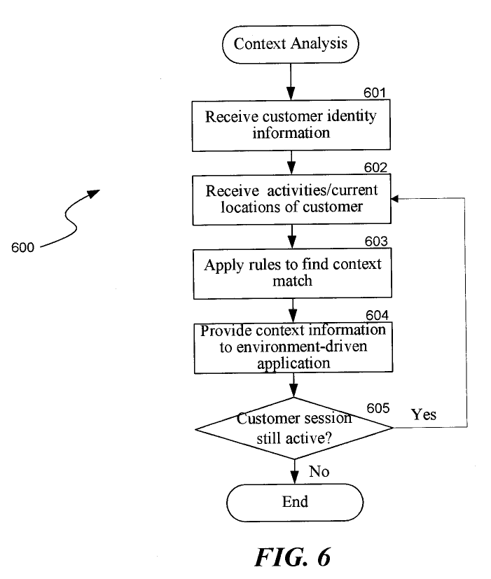

FIG. 6 is a flow diagram showing an example of a context analysis routine 600 in one embodiment where context analysis is performed in a component other than the environment-driven application. For example, the context analysis routine 600 may be performed at the context analysis component 120 of FIG. 1. At block 601, the routine 600 receives customer identity information (e.g., an indication that a customer has entered the environment and an indication of the identity of that customer). At block 602, the routine 600 receives current or near current information about the activity and/or location of the customer within the environment. At block 603, the routine 600 applies rules to find a context match for the customer based on the received information. For example, the applied rules may allow the routine 600 to determine that the customer is having problems making a deposit using an ATM (determined by locating the customer at the ATM and applying a set of rules to the customer activities at the ATM). At block 604, the routine 600 provides the context information to the environment-driven application, which may, for example, indicate to a customer service agent that the customer at the ATM machine needs assistance. At decision block 605, the routine 600 determines whether the customer session is still active. If at decision block 605, the customer session is still active (i.e., the customer has not yet left the environment), the routine 600 loops back to block 602, where it continues to receive activity/location information for the customer (and then applies the received information at blocks 603 and 604). If, however, at decision block 605, the routine 600 determines that the customer session is no longer active, the routine 600 ends.

FIG. 7 is a flow diagram showing an example of a routine 700 performed at an environment-driven application in a first embodiment. At block 701, the routine 700 receives customer context status information (e.g., from the context analysis component of FIGS. 1 and 4, which performs the routine 600 of FIG. 6). At block 702, the routine 700 applies the context/status information to result in the presentation of customer information on a customer service interface. For example, based on the applied context/status information, the routine 700 may display that a customer in the environment needs assistance with a specified task. In another example, based on the applied context/status information, the routine 700 may display a customer's account information on a screen so that a customer service agent is ready to help the customer as soon as the customer arrives at the customer service station. The routine 700 ends after block 702.

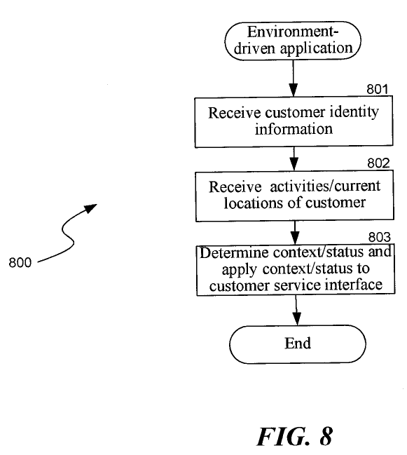

FIG. 8 is a flow diagram showing an example of a routine 800 performed at an environment-driven application in a second embodiment, where the environment-driven application itself performs all or part of the context analysis needed to determine the current or near current context of the customer to appropriately drive the environment-driven application. At block 801, the routine 800 receives customer identity information. At block 802, the routine 800 receives activity and/or current location information for the customer. At block 803, the routine 800 determines a context or status for the customer and applies the context or status to a customer service interface 800 to facilitate providing customized customer service or assistance to the customer. The routine 800 ends after block 803.

IV. Sample User Interface

FIG. 9 is a display diagram showing a bank branch “dashboard” application screen 900 used to provide customer service representatives and other bank employees with a collaborative workspace and an overview of current branch activities (e.g., the identity, current location, and current actions of each bank customer who is currently in the vicinity of the bank branch). The dashboard 900 may be used to implement strategies such as customer service prioritization based on customer awareness, location, and identification. For example, as illustrated, the dashboard may provide a map 902 and corresponding listing 904 of the location of each customer in the branch (e.g., “customer: Sara Gifford with teller Andrea”). It may also provide alerts 906 to indicate situations where immediate action may be necessary (e.g., “assist high-value customer, Suzi Charbonnet (kiosks)”). More generally, the dashboard shows customers entering the branch and going about their business, accessing kiosks, meeting with tellers, and performing various functions/ transactions in the environment. Meanwhile, employees move about the branch serving customer needs. High-value customers are instantly matched with senior specialists who either have already established a personalized relationship with the customer or who could otherwise best serve that particular customer. Other customers are assigned with an employee to help based on predicted availability or proximity. Recurring branch tasks, such as customer courtesy calls, are distributed to relevant employees by the system at relevant times when employee availability permits.

Having the detailed customer information provided by the bank branch dashboard at hand gives employees ways to quickly access customer information (e.g., on a range of devices) and provide immediate, informed, and personalized customer service. It may also allow for the generation/management of tasks and workflows. More specifically, the dashboard's collaborative workspace may provide a range of seamless employee communications, and, when coupled with predictive technologies, resulting workflows may be managed using system-generated tasks that identify when, where, and how certain tasks could be best assigned. For example, using a combination of predictive technologies, customer location awareness, employee availability tracking, and best matching practices, it is possible to quickly and efficiently match tellers with customers in a way that will most quickly satisfy the customers'needs. To illustrate, if customer Suzi Charbonnet needs access to her safe-deposit box, she may be immediately matched with one of the bank employees who has access to the safe. Whereas if customer Sara Gifford merely needs to cash a check, she may be immediately matched to the first employee who is not currently helping another customer.

In some embodiments, the availability of presence/identify information may allow customers to be served more quickly by allowing this information to modify the state of an application on which the teller is working. For example, if a teller system/application is able to anticipate the arrival of the next customer in the queue, it can then “pull up” the appropriate account/profile information as that customer steps up to the counter for assistance. The teller is immediately able to greet the customer by name and avoid wasting time asking for name and account information in the first minutes of their interaction. In some embodiments, biometric data and various forms of authentication, including a photo of the customer stored as part of the customer's profile information available to the teller, may allow for a verification of customer identity (e.g., without having to trouble the customer). The time savings that may be realized may, for example, allow employees to focus on building a deeper understanding of their customers and may provide employees with the opportunity to act upon “next best lead” opportunities in each interaction.

From the foregoing, it will be appreciated that specific embodiments have been described herein for purposes of illustration, but that various modifications may be made without deviating from the spirit and scope of the invention. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

I/We claim:

1. A system for providing enhanced customer service within an environment, the system comprising:
a customer identification subsystem configured to automatically identify a customer that has entered the environment;
a customer tracking subsystem configured to automatically track activities, current locations, or both activities and current locations of the identified customer within the environment;
a context processing component configured to determine a current or near current context for the identified customer based on information provided by the customer identification subsystem and the customer tracking subsystem; and
at least one environment-driven application configured to use customer context information provided by the context processing component to facilitate providing customized customer service to the customer.

2. The system of claim 1 wherein the environment is a banking environment and wherein the even driven application is a banking application that provides alerts to customer service representatives regarding the potential needs of customers within the environment.

3. The system of claim 1 wherein the environment is a banking environment and wherein the environment-driven application is a banking application that provides indications of customers entering the banking environment and conducting activities within the banking environment, including performing transactions at stations within the banking environment.

4. The system of claim 1 wherein the environment is a banking environment and wherein the even driven application is a banking application that provides information that facilitates customer service employees moving about the banking environment to serve customer needs.

5. The system of claim 1 wherein the environment is a banking environment and wherein the even driven application is a retail bank application that provides information that facilitates matching customer service employees with customers according to current locations or activities of customers within the banking environment, as identified by the retail bank application.

6. The system of claim 1 wherein the environment is a banking environment and wherein the even driven application is a banking application providing a dashboard interface including an dynamic map and a corresponding listing of locations of each customer in the banking environment.

7. The system of claim 1 wherein the environment is a banking environment and wherein the even driven application is a banking application providing a collaborative workspace and an overview of current or near current banking environment activities including providing an indication of the identity, current location, and current action of the customer within the banking environment.

8. The system of claim 1 wherein the environment is a banking environment and wherein the even driven application is a banking application providing customer service prioritization services based on customer awareness, location, and identification.

9. A method for providing enhanced service to a customer within an environment, the method comprising:
receiving customer identity information obtained in association with automatically identifying a physical presence of the customer in the environment;
receiving customer activity information obtained in association with automatically tracking activities performed by the customer in the environment;
determining a current or near current activity status for the identified customer based on the received customer identity information and the received customer activity information; and
providing an indication of the current or near current activity status for the identified customer to an environment-driven application configured to facilitate providing customized services to the customer.

10. The method of claim 9 wherein the environment-driven application facilitates a customer service agent greeting the customer by name as the customer approaches a customer service station without the customer having to identify himself or herself.

11. The method of claim 9 wherein the environment-driven application facilitates matching the customer with a customer service agent.

12. The method of claim 9 wherein the environment-driven application is further configured to facilitate human verification of the received customer identity information.

13. The method of claim 9 wherein the customer retains control over the extent and scope of the received customer identity information by providing customer preferences during a registration process.

14. The method of claim 9 further comprising:
receiving registration information from the customer; and
generating a user profile for the customer based on the received registration information, wherein the generated user profile facilitates the automatic identification of a physical presence of the customer in the environment.

15. The method of claim 9 wherein automatically identifying a physical presence of the customer in the environment does not require that the user expressly provide identity information.

16. The method of claim 9 wherein automatically identifying a physical presence of the customer in the environment includes identifying the customer based on biometric or facial recognition criteria.

17. The method of claim 9 wherein determining a current or near current activity status for the identified customer based on the received customer identity information and the received customer activity information comprises:
retrieving a customer profile for the customer;
processing the received customer activity information to determine an activity match from a set of stored activity options; and
applying the customer profile information to the determined activity match.

18. The method of claim 9 wherein the automatic tracking of activities performed by the customer in the environment includes tracking the physical location of the customer within the environment over time.

19. The method of claim 9 wherein the environment is an environment other than a banking environment.

20. A computer-readable medium associated with an environment-driven application, the computer-readable medium containing instructions for performing a method comprising:
receiving an indication of identity information obtained in association with automatically identifying a physical presence of a person in an environment in which the person may request assistance or services;
receiving an indication of current or near current status information for the person, wherein the status information is obtained in association with automatically tracking activities and/or locations of the person within the environment; and
applying the received indication of identity information and the received indication of current or near current status information to update an interface that facilitates providing customized customer service or assistance to the person.
